(19) United States
(12) Patent Application Publication
(10) Pub. No.: US 2026/0281123 A1
(43) Pub. Date: Sep. 17, 2026

(54) COMPUTER-ASSISTED FILLING OF VERIFICATION CODES FROM MESSAGES

(71) Applicant: GOOGLE LLC, Mountain View, CA (US)

(72) Inventors: Jeremy Brandon Roman, Kitchener (CA); Iman Saboori, Vaughan (CA); Irene Chang, Brooklyn, NY (US); Matthew Spencer Rendely, Seattle, WA (US)

(21) Appl. No.: 19/080,240

(22) Filed: Mar. 14, 2025

(51) Int. Cl. H04L 9/40

(52) U.S. Cl. CPC H04L 63/123; H04L 63/083

(57) ABSTRACT

Techniques involve determining, in response to receiving a request to locate a verification code sent to a user's email account as part of an authentication process for accessing a resource, identifying a message associated with a resource on an email server. Once this message has been identified, a model such as a generative model is used to analyze the message and provide an indication of whether or not the message includes the verification code and, when the message likely includes the verification code, to provide the verification code. In response to determining that the analysis indicates that the message includes the verification code, the verification code is sent to the client device.

### BACKGROUND

Some websites provide a resource for a user to access. Many times, the website requires the user to demonstrate that they are authorized to access the resource. One way to demonstrate such authorization is to require that the user submit a password to the website that demonstrates what the user knows. Some websites require, in addition to a password, an additional factor for authentication that demonstrates what the user has. An example of such an additional factor for authentication is a one-time password, also sometimes referred to as a verification code, generated by the website or a third party.

### SUMMARY

Implementations are directed to providing a technique for automatically inputting a verification code (one-time password) used in two-factor authentication into a website for authorizing a user to access a resource when the verification code is sent to an email account of the user. This allows the user to access the resource without requiring the user to leave the website and manually access the user's email account. For example, when a dialog window indicating that a verification code was sent to the user's email account is displayed in a browser window of a browser running on a client device, the client device, e.g., via the browser, sends a request to obtain the verification code from the user's email account to a coordinating server. Upon receiving the request, the coordinating server accesses the user's email account and identifies a message of the email account that is associated with the resource. A message is associated with a resource when the message is from a domain associated with the resource. The domain associated with the resource may be included in the request from the browser. A message is associated with a resource when the message has a subject line indicating the message relates to a verification code/one-time password. In some implementations, a message may be associated with the resource when it is received within a predetermined time from the request from the browser. The coordinating server then analyzes the message using a generative model (such as a large language model, multi-modal generative model, etc.) to provide an indication of whether or not the message includes the verification code. In response to determining that the analysis of the message indicates that the message includes the verification code, the coordinating server sends the verification code to the client device, whereupon the verification code is automatically input into the dialog window and transmitted to a server hosting the website so that the user may access the resource.

In one general aspect, a method includes receiving, from a client device configured to display a resource upon successful authentication of a user, a request to locate a verification code in a communications account of the user. The method also includes identifying a message of the communications account that is associated with the resource. The method further includes obtaining an output from a model that takes the message as input, the output providing an indication of whether or not the message includes the verification code. The method further includes, in response to determining that the output indicates the message includes the verification code, sending the verification code as a response to the request to the client device.

In another general aspect, a computer program product comprising a nontransitory storage medium, the computer program product including code that, when executed by processing circuitry, causes the processing circuitry to perform a method, the method includes receiving, from a client device configured to display a resource upon successful authentication of a user, a request to locate a verification code in a communications account of the user. The method also includes identifying a message of the communications account that is associated with the resource. The method further includes obtaining an output from a model that takes the message as input, the output providing an indication of whether or not the message includes the verification code. The method further includes, in response to determining that the output indicates the message includes the verification code, sending the verification code as a response to the request to the client device.

In another general aspect, an apparatus includes memory and a processor coupled to the memory. The processor is configured to receive, from a client device configured to display a resource upon successful authentication of a user, a request to locate a verification code in a communications account of the user. The processor is also configured to identify a message of the communications account that is associated with the resource. The processor is further configured to obtain an output from a model that takes the message as input, the output providing an indication of whether or not the message includes the verification code. The processor is further configured to, in response to determining that the output indicates the message includes the verification code, send the verification code to the client device.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example display of a dialog window prompting for a verification code that has been sent to an email account of a user, in accordance with implementations described herein.

FIG. 2 is a diagram illustrating an example system including a client device, servers, and networks configured to automatically enter a verification code sent in a message to a user's email account, in accordance with implementations described herein.

FIG. 3 is a flow chart illustrating an example method of automatically entering a verification code sent in a message to a user's email account.

### DETAILED DESCRIPTION

Some websites provide a resource for a user to access. Many times, the website requires the user to demonstrate that they are authorized to access the resource. One way to demonstrate such authorization is to require that the user submit a password to the website that demonstrates what the user knows. Some websites require, in addition to a password, an additional factor for authentication that demonstrates what the user has. An example of such an additional factor for authentication is a verification code generated by the website or a third party.

A verification code as defined herein is a sequence of symbols (e.g., a string) that are sent to a user account in order to provide a user access to a resource. An example of a verification code is a one-time password. A one-time password is a randomly-generated sequence of symbols (including characters, numbers, special characters, etc.) that is sent to an account of the user on a device the user may have. In one example, a one-time password is sent to a dedicated device given to the user by an administrator of a website. In this case, knowledge of the one-time password proves possession of the dedicated device to the administrator, which is sufficient to grant access to the resource to the user. In another example, a one-time password is sent to a user's mobile phone via SMS. In this case, knowledge of the one-time password proves possession of the mobile phone to the administrator, which is sufficient to grant access to the resource to the user.

This disclosure, however, is directed to a verification code sent in a message to a communications account of a user such as an email account or a voice mail account. In the case of email, such a situation may arise because a user has opted not to provide their mobile phone number or because the administrator has determined that verification using SMS is not as secure as verification using email. A communications account resides on a communications server and may be accessed in any number of ways from such a client device. In one example, the user may access the communications account on the client device either through a dedicated application or via the browser on, e.g., a new tab. In another example, the user may access the communications account via another device, e.g., a mobile phone.

A conventional approach to accessing the resource using a verification code sent to a communications account involves the user manually accessing the communications account. Once the user accesses the communications account, the user determines whether the message has arrived in the account, and if so, determines which message in the account is the one that has the verification code. For example, a recent email from an email domain that is the same as the website providing the resource is likely the email with the verification code. The user then opens the email and identifies the verification code in the email. The user may perform the identification by locating, for example, a sequence of digits among the content of the email. The user then copies the sequence of digits into the form field in the browser window and, if the sequence of digits is the verification code, access is granted to the resource.

A technical problem with the conventional approach to accessing the resource using a verification code sent to a communications account is that the conventional approach requires the user to perform a number of manual steps to retrieve the verification code, such as navigating away from the site or app that is requesting the code, finding the communications client (or opening a new tab and logging in to the communications account), waiting until the message arrives, opening the message, finding the code, copying the code, and navigating back to the site or app requesting the code, etc. Such manual steps interfere with the user's productivity in the course of accessing the resource and uses additional computing resources (such as battery and memory to re-render the user interfaces), limiting the viability of using verification codes with email accounts.

In some cases, the browser can automatically access messages from the email account on the client device, e.g., messages that have been downloaded onto the client device. Nevertheless, even if the client device can determine the correct message containing the verification code, the client device may be ill-equipped to identify the verification code from among the content in the message. This is especially true if the verification code does not follow a specified format (e.g., six digits) and the content of the message is verbose.

A technical solution to the technical problem involves, in response to receiving an indication that a verification code was sent to a user's communications account, identifying a message of the communications account on a communications server that likely contains the verification code. Once this message has been identified, a model such as a generative model is used to analyze the message and provide an indication of whether or not the message includes the verification code. In response to determining that the analysis indicates that the message includes the verification code, the verification code is sent to the client device.

A technical advantage of the technical solution lies with the streamlining of the two-factor authentication process when the verification code is sent to a communications account, thus improving the computer-user interactions and conserving computing resources. Moreover, because the identification of the verification code occurs at the server rather than client device, no specific communications client need be used and messages can be identified before they are delivered to the device. Additionally, the use of a generative model enables implementations to identify any verification code independent of any specified format.

The foregoing examples will have the communications account being or including an email account. Nevertheless, in no way do such examples limit the above-described technology to email accounts. For example, the foregoing examples may be applied to voice mail accounts or any other communications account that supports long-form messages (e.g., messages with more than 200 characters).

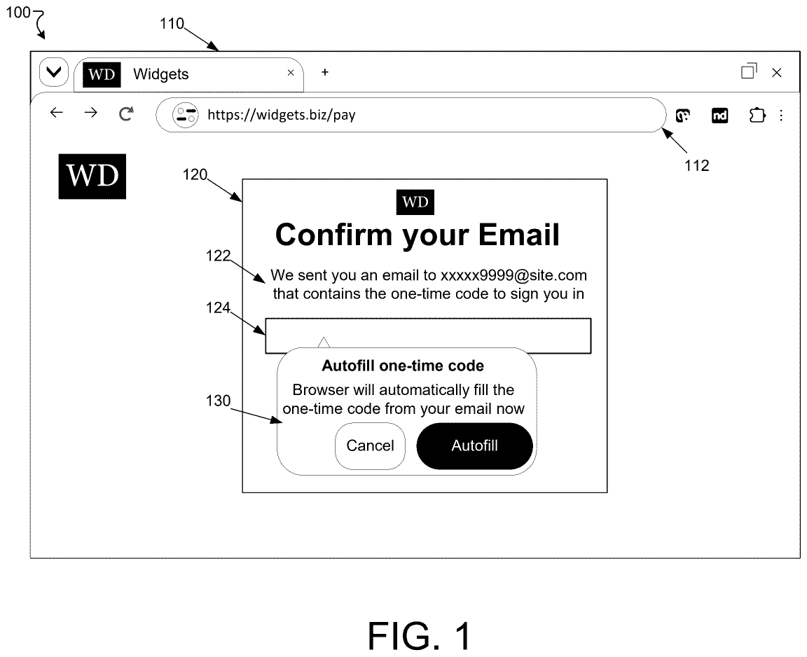

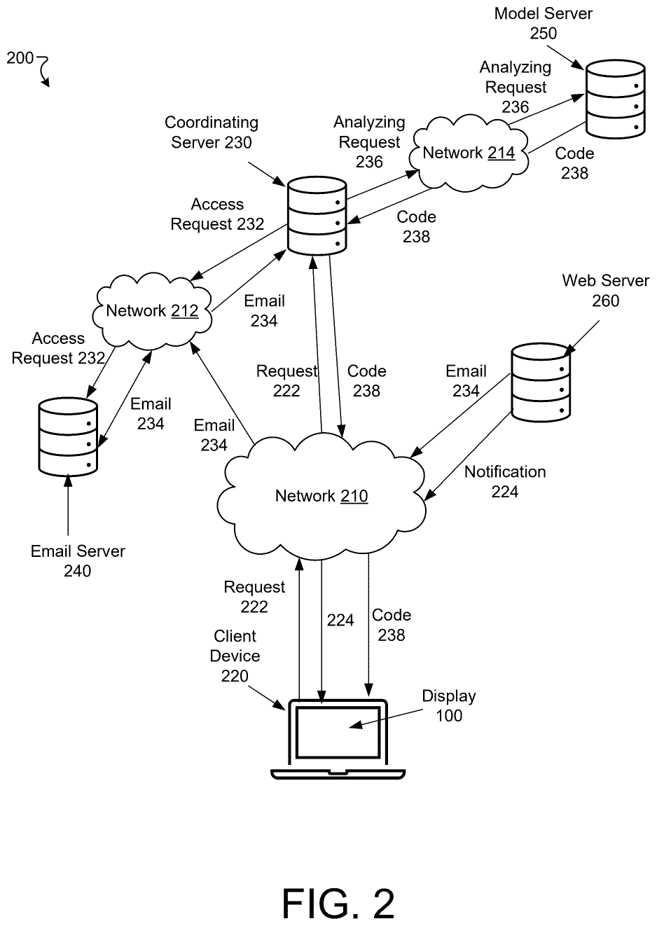

FIG. 1 is a diagram illustrating an example display 100 of a client device (e.g., client device 220 of FIG. 2) displaying a dialog window 120 prompting for a verification code that will be sent to an email account of a user.

As shown in FIG. 1, the display 100 of the client device displays a browser window 110, or graphical user interface (GUI) of a browser (Internet browser) configured to run on the client device. The browser is software that accesses information from a web server (e.g., web server 260 of FIG. 2) remote from the client device, interprets the information, and displays the information in graphical form in a browser window, e.g., browser window 110. The web server is identified through a web address input into a web address bar 112. As shown in FIG. 1, the web address that the browser has accessed is https://widgets.biz/pay.

The web server hosts a website that provides information and/or services to the client device. In one example, a website can offer information about products for sale; such information usually does not require authentication for access. In another example, however, a website can offer access to a resource such as an account that has sensitive information. Sensitive information can include personally identifiable information, bank account information, credit account information, investment account information, and the like. Sensitive information usually requires some form of authentication for a user to be granted access.

A common form of authentication takes the form of a password. During a registration process in a previous visit to the website, the user is asked to establish an account by specifying a username by which the account is identified and a password by which the user is granted access to the account. In this way, the account becomes the resource that the user-or an imposter-may attempt to access. When the user, during a later session, requests access to the account, e.g., by clicking on a button in the browser window, the website may display text boxes for inputting the username and password.

A simple password, however, frequently does not provide sufficient security to prevent access to the resource by an imposter. For example, passwords may be easily guessed or cracked using automated software. In response, many websites require two-factor authentication, requiring a second factor of authentication. Frequently, whereas the first factor—the password—represents something that the user knows, the second factor frequently represents something that the user has, e.g., a device or another account.

As shown in FIG. 1, the second factor is an email account of the user. In this case, when the user inputs their username and password, the website, in response to receiving the username and password and verifying that the password correctly corresponds to the username, provides a window explaining to the user that a verification code was sent to an email account that the user specified during the registration process.

Such a window is shown in FIG. 1 as a dialog window 120. Here, it is assumed that the user successfully input a username and password corresponding to the username. The dialog window 120 includes explanatory text 122 explaining that a verification code (“one-time code”) has been sent to an email account, which is presumably the user's email account. The dialog window 120 also includes a text box 124 for inputting the verification code once the verification code has been retrieved from the email account listed in the explanatory text 122.

The retrieval of the verification code from the email account occurs at an email server hosting the email account. One reason for the retrieval occurring at the email server is because the client device is not equipped to be able to consistently identify verification codes from email messages that do not conform to a prespecified format. Another reason for the retrieval occurring at the email server is that waiting until the client device downloads the messages from the email server may be slower and more resource intensive. For example, different websites may have completely different formats for verification codes and the messages that contain those codes. One verification code may consist of six digits, while another verification code may consist of a sequence of twenty alphanumeric characters embedded within dense content. While a client device may not be equipped to consistently identify these verification codes, a tool such as a generative model is equipped to identify such diverse types of verification codes. Such a model is usually hosted on a server remote from the client device. Accordingly, it is better to perform the identification of the verification code remote from the client device.

As shown in FIG. 1, once the dialog window 120 is displayed in the browser window 110, the website displays an additional dialog window 130. The additional dialog window 130 provides the user with the option to acquire the verification code from the email server automatically. As shown in FIG. 1, the additional dialog window 130 enables the user to acquire the verification code from the email server automatically by clicking on the “Autofill” button. Also, the additional dialog window 130 enables the user to opt out of acquiring the verification code from the email account automatically, e.g., choosing to acquire the verification code manually, by clicking on the “Cancel” button. In some implementations, the “Cancel” button is not present and there is no opt-out of automatic acquisition of the verification code from the email account.

One issue that may arise in automatically acquiring the verification code from the email server is that access to the email account requires its own login. One way to address this is to note that frequently the user is already logged into their email account at the time of acquiring the verification code. Nevertheless, if the email account is associated with a stored credential associated with the browser, then the email account is accessible from the website without requiring a manual login from the user. In some implementations, the stored credential is an OAuth 2.0 token.

FIG. 2 is a diagram illustrating an example system 200 configured to automatically enter a verification code sent in an email. As shown in FIG. 2, the system 200 includes a client device 220, a coordinating server 230, an email server 240, a model server 250, a web server 260, and networks 210, 212, and 214.

The client device 220 is configured to receive content from the web server over network 210, the content including content from a website hosted on the web server 260. Some of the content includes a resource that is only displayed to the user upon successful authentication of the user. The client device 220 is also configured, with user consent, to send a request 222 to the coordinating server as an indication that the verification code sent to the user's email account is to be acquired and sent back to the client device 220. The client device 220 can be a desktop computer, a laptop computer, a tablet computer, a smartphone, a virtual reality/augmented reality/extended reality device, or the like.

The email server 240 is configured to host email accounts including the user's email account. Each such email account includes any number of elements (messages). Each message has elements including a subject header, a timestamp indicating a time at which the email was received at the email server 240, and content or the body of the email message.

The model server 250 is configured to host a generative model. The generative model is configured to analyze content of a message by performing natural language processing on the message. The output of the generative model provides an indication of whether or not the message includes the verification code.

The coordinating server 230 is configured to receive the request 222 from the client device 220 over the network 210 to acquire the verification code from the user's email account. The coordinating server 230 is also configured to access the user's email account on the email server 240 over the network 212 and identify a message that is associated with the resource. The coordinating server 230 is further configured to access a generative model, such as a large language model, on the model server 250 over the network 214 for analyzing the message from the user's email account to provide an indication of whether or not the analysis indicates that the message includes the verification code 238. The coordinating server 230 is further configured to send the verification code 238 to the client device 220.

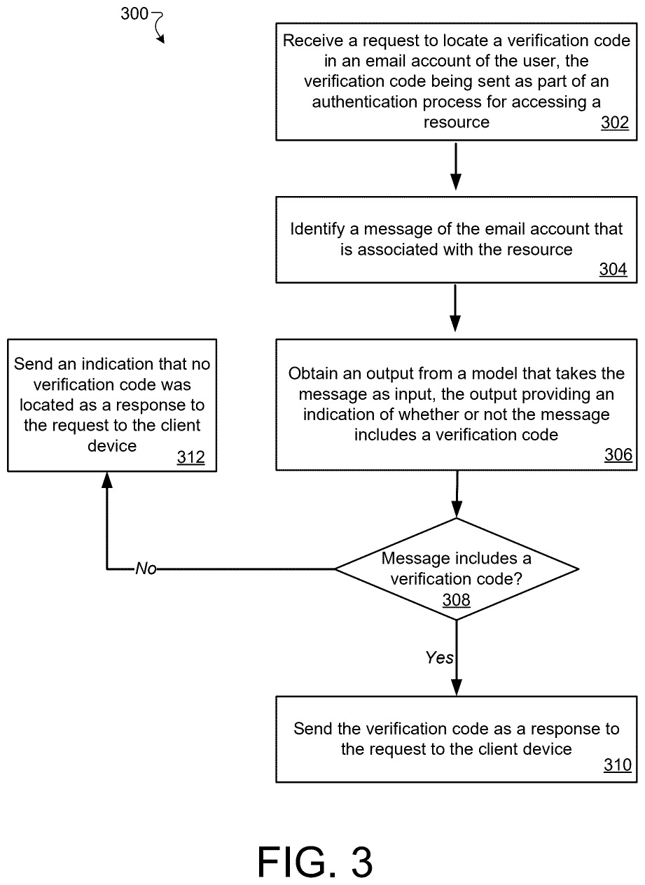

The coordinating server 230 can include a memory and a processor coupled to the memory. The memory can include both volatile memory (e.g., RAM) and non-volatile memory, such as one or more ROMs, disk drives, solid state drives, and the like. The processor and the memory together are configured to perform various methods and functions including those described above. Also, a computer program product can include a nontransitory storage medium, the computer program product including code that, when executed by a processor, causes the processor to perform a method as described herein (e.g., with regard to FIG. 3).

The web server 260 is configured to host the website that is communicated to the client device 220 over the network 210 and displayed in the display 100 (within a browser window, e.g., browser window 110). The web server 260 is also configured to receive the verification code 238 from the client device 220 over the network 210.

The networks 210, 212, and 214 may take the form of, e.g., a local area network (LAN), wide area network (WAN), the Internet, or a combination thereof. In some examples, the network 210 can be accessed over a wired and/or a wireless communications link. For example, when the client device is a mobile computing device, such as a smartphone or tablet computer, the client device can utilize a cellular network to access the network 210. While FIG. 2 shows networks 210, 212, and 214 as separate networks, in some implementations networks 210, 212, and 214 form a single network.

During operation, the web server 260, upon receiving correct login credentials, e.g., username and password, from the client device 220 for accessing a resource from the web server 260, generates the verification code 238 and sends a message 234 containing the verification code 238 to the user's account on email server 240 via networks 210 and 212. The verification code 238 is an arbitrary sequence of symbols and can be of any length and is not required to conform to any specified format.

The message 234 may have a subject, an originating address associated with a web domain, a timestamp, and a body. The subject usually indicates that a verification code is contained in the body, e.g., “Your verification code,” but this is not always the case. For example, for security purposes, the subject may not indicate that there is a verification code at all. The originating address may be the domain of the web server 260 which sent the message 234, e.g., “widgets.biz.” The timestamp may indicate a time at which the message 234 arrived at the email server 240. The body includes the content of the message, among which may include the verification code 238. The verification code 238, if in the body of the message, can be anywhere within the body but in many cases, the verification code 238 may be at the beginning of the body.

At about the same time as when the web server 260 sends the message 234, the web server 260 also sends a notification 224 to the client device 220 via the network 210. The notification 224 notifies the user that the message 234 containing the verification code 238 has been sent to the user's email account. The notification 224 may be displayed in the web browser as, e.g., dialog window 120.

After the notification 224 is sent to the client device 220, the client device 220 sends a request 222 to the coordinating server 230. For example, the user, upon seeing the dialog window 120 and additional dialog window 130, decides to acquire the verification code 238 automatically and clicks on the “Autofill” button. The request 222, in some implementations, takes the form of a data packet identifying the user's email account, the originating web domain of the website provided by the web server 260, and an indication that the user is logged into the user's email account on the email server 240. In some implementations, the data packet also includes a timestamp that indicates a time at which the notification 224 was received at the client device 220.

Upon receiving the request 222, the coordinating server 230 sends an access request 232 to the email server 240 over the network 212. In some implementations, the access request 232 is a data packet identifying the user's email account and providing an indication that the user has provided authentication for logging into the user's email account. In some implementations, the email server 240 sends a response back to the coordinating server 230 over the network 212 indicating permission to access the user's email account. Upon receiving the response, the coordinating server 230 accesses, over the network 212, the user's email account on the email server 240.

Upon accessing the user's email account on the email server 240, the coordinating server 230 searches for and identifies the message 234 that is associated with the resource. For example, the coordinating server 230 may search for messages originating from the email source (e.g., “widgets.biz”) that were received at a time later than that indicated in the timestamp of the request 222 and have a source address that matches that in the request 222. In some implementations, the coordinating server searches for messages that contain a subject having the text “verification code,” or text that indicates that a verification code is contained in the body of the message 234.

After determining the message 234, the coordinating server 230 acquires a copy of the message 234 over the network 212. The coordinating server 230 then sends an analyzing request 236 to the model server 250 over the network 214. The analyzing request 236 may include one or more data packets which includes the content of the body of the message 234 and instructions to locate the verification code 238 within the content. For example, the instructions to locate the verification code 238 may take the form “locate a verification code within the included content.”

The model server 250, upon receiving the analyzing request 236, runs a generative model on the content according to the instructions sent in the analyzing request 236. Generative models, are large deep learning models with multiple layers and a high number of parameters that learn the probability distribution of underlying data. In some cases, such models are pre-trained on vast amounts of data. Such models can generate answers about a body of text, summarize the text, etc. A generative model may include a set of neural networks that consist of an encoder and a decoder with self-attention capabilities. The encoder and decoder extract meanings from a sequence of text and understand the relationships between words and phrases in it.

The generative model analyzes the content by performing natural language processing on the content and produces an output using the message 234 as input. The output provides an indication of whether or not the message 234 includes the verification code 238. It is noted that the generative model is capable of identifying the verification code 238 independent of any particular format. This is because the generative model uses natural language processing to identify the verification code 238 from the context of the content, much as a human might manually identify the verification code 238, if the verification code 238 is present in the message 234.

The coordinating server 230 may determine that the output indicates that the message 234 includes the verification code 238. In response to this determination, the coordinating server 230 sends the verification code 238 to the client device 220 over the network 210. The client device 220, via the browser, automatically inputs the verification code 238 into a text box (e.g., text box 124) in the notification (e.g., dialog window 120). The user may then cause the client device 220 to send the verification code 238 (e.g., by clicking on a “send” button in the notification) to the web server 260 for authentication. When the web server 260 verifies that the verification code 238 is correct, the web server provides the user with access to the resource.

The above can be applied to communications other than email. For example, the above can be applied to voice mails in a voice mail account on a voice mail server or any other server that supports long-form messages (e.g., messages with more than 200 characters).

FIG. 3 is a flow chart illustrating a method 300 of automatically entering a verification code sent to a user's communications account. The method 300 may be performed in a processor of a coordinating server (e.g., coordinating server 230 shown in FIG. 2).

At 302, the coordinating server receives, from a client device (e.g., client device 220) configured to access a resource upon successful authentication of a user, a request (e.g., request 222) to locate a verification code (e.g., verification code 238) in a communications account of the user. The request may be sent with user consent to have the verification code automatically identified by the coordinating server.

At 304, the coordinating server identifies a message (e.g., message 234) of the communications account that is associated with the resource. In some implementations, the coordinating server 230 accesses an email server 240 in order to perform the identification. In some implementations, if there is no message identified (e.g., because it has not been delivered yet), then the coordinating server 230 may poll the email server 240, or register for a notification, to learn when a message arrives that the coordinating server 230 may evaluate. Although not illustrated in FIG. 3, as part of step 304, if no message is identified after a predetermined time, the coordinating server may determine that no messages include a verification code and proceed to step 312. In some implementations, more than one message may be identified as associated with the resource. In such implementations, steps 306 and 308 are understood to be performed for each message. In such implementations, each message may have a respective model output with an indication of whether or not the message includes a verification code. In some such implementations, the respective model output may include a confidence score for the indication. In such implementations, the coordinating server may provide, as part of step 310, a verification code that has a highest confidence score.

At 306, the coordinating server obtains an output from a model that takes the message as input, the output providing an indication of whether or not the message includes a verification code. In some implementations, the model is a generative model such as a large language model running on a model server (e.g., model server 250).

At 308, the coordinating server determines whether the output from the model indicates the message includes the verification code. In some implementations, the model output may include a string. The string may be a numeric string. The string may be an alphabetic string, The string may be an alpha-numeric string. The string may include special characters. The presence of a string may indicate the message includes a verification code associated with the resource and the absence of the string may indicate the message lacks a verification code associated with the resource. In some implementations, a binary parameter may indicate whether or not the message includes a verification code associated with the resource. A first value of the binary parameter may indicate a string included in the output is the verification code. A second value of the binary parameter may indicate the message lacks a verification code associated with the resource. In some implementations, the output of the model may include a confidence score. The confidence score reflects a level of certainty (probability) that the message includes a verification code. If the output includes a string or the first value of the binary parameter but the confidence score fails to meet a certainty threshold, the coordinating server may determine that the message does not include a verification

At 310, the coordinating server, in response to determining that the output indicates the message includes a verification code (308, Yes), sends the verification code as a response to the request to the client device. At 312, the coordinating server, in response to determining that there is no verification code in the message (or, if multiple messages, in any of the messages or if the respective confidence score/scores are not high enough), may provide an indication that no verification code was located as the response to the request.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the disclosed implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A method, comprising:
receiving, from a client device, a request to locate a verification code in a communications account of a user, the verification code being sent as part of an authentication process for accessing a resource;
identifying a message of the communications account that is associated with the resource;
obtaining an output from a model that takes the message as input, the output providing an indication of whether or not the message includes a verification code, wherein the output includes the verification code with an indication of the message including a verification code; and
in response to the output indicating the message includes the verification code, sending the verification code as a response to the request to the client device.

2. The method as in claim 1, wherein the model is a generative model configured to perform natural language processing on the message to provide the indication of whether or not the message includes the verification code.

3. The method as in claim 1, wherein the resource is associated with a web domain; and
wherein identifying the message of the communications account that is associated with the resource includes:
identifying, as the message, an element of the communications account originating from an address associated with the web domain.

4. The method as in claim 1, wherein the request includes a timestamp indicating a time at which the verification code was requested; and
wherein identifying the message of the communications account that is associated with the resource includes:
identifying, as the message, an element of the communications account received later than the time indicated by the timestamp.

5. The method as in claim 1, wherein the communications account includes an email account.

6. A computer program product comprising a nontransitory storage medium, the computer program product including code that, when executed by a processor, causes the processor to perform a method, the method comprising:
receiving, from a client device, a request to locate a verification code in a communications account of a user, the verification code being sent as part of an authentication process for accessing a resource;
identifying a message of the communications account that is associated with the resource;
obtaining an output from a model that takes the message as input, the output providing an indication of whether or not the message includes the verification code, wherein the output includes the verification code with an indication of the message including a verification code; and
in response to the output indicating the message includes the verification code, sending the verification code as a response to the request to the client device.

7. The computer program product as in claim 6, wherein the model is a generative model configured to perform natural language processing on the message to provide the indication of whether or not the message includes the verification code.

8. The computer program product as in claim 6, wherein the resource is associated with a web domain; and
wherein identifying the message of the communications account that is associated with the resource includes:
identifying, as the message, an element of the communications account originating from an address associated with the web domain.

9. The computer program product as in claim 6, wherein the request includes a timestamp indicating a time at which the verification code was requested; and
wherein identifying the message of the communications account that is associated with the resource includes:
identifying, as the message, an element of the communications account received later than the time indicated by the timestamp.

10. The computer program product as in claim 6, wherein the communications account includes an email account.

11. An apparatus, comprising:
memory; and
a processor coupled to the memory, the processor being configured to:
receive, from a client device, a request to locate a verification code in a communications account of a user, the verification code being sent as part of an authentication process for accessing a resource;
identify a message of the communications account that is associated with the resource;
obtain an output from a model that takes the message as input, the output providing an indication of whether or not the message includes the verification code, wherein the output includes the verification code with an indication of the message including a verification code; and
in response to the output indicating the message includes the verification code, send the verification code as a response to the request to the client device.

12. The apparatus as in claim 11, wherein the model is a generative model configured to perform natural language processing on the message to provide the indication of whether or not the message includes the verification code.

13. The apparatus as in claim 11, wherein the resource is associated with a web domain; and
wherein the processor configured to identify the message of the communications account that is associated with the resource is further configured to:
identify, as the message, an element of the communications account originating from an address associated with the web domain.

14. The apparatus as in claim 11, wherein the request includes a timestamp indicating a time at which the verification code was requested; and
wherein the processor configured to identify the message of the communications account that is associated with the resource is further configured to:
identify, as the message, an element of the communications account received later than the time indicated by the timestamp.

15. The apparatus as in claim 11, wherein the communications account includes an email account.
